(19) United States
(12) Patent Application Publication
(10) Pub. No.: US 2012/0105562 A1
(43) Pub. Date: May 3, 2012

(54) IMAGE FORMING METHOD AND IMAGE FORMING APPARATUS

(75) Inventors: Keiko Sekiguchi, Mishima-shi (JP); Keiichirou Takeuchi, Tokyo (JP)

(73) Assignee: CANON KABUSHIKI KAISHA, Tokyo (JP)

(21) Appl. No.: 13/281,720

(22) Filed: Oct. 26, 2011

(30) Foreign Application Priority Data
Nov. 1, 2010 (JP) 2010-245490

(51) Int. Cl. B41J 2/01

(52) U.S. Cl. 347/103

(57) ABSTRACT

By an image forming method in which after a first liquid for aggregating a color material of an ink to be used and a second liquid which performs a gel reaction with the first liquid are supplied on an intermediate transfer member, the ink is supplied to a region on which the first liquid and the second liquid are supplied to form an intermediate image on the intermediate transfer member, and the intermediate image is transferred to a recording medium, the fluidity of an aggregation process liquid supplied to the intermediate transfer member is effectively decreased, and good image transfer is performed.

### BACKGROUND OF THE INVENTION

1. Field of the Invention

The present invention relates to a transfer type ink jet recording technique using an intermediate transfer member.

2. Description of the Related Art

In transfer type ink jet recording, as a pretreatment for forming an intermediate image on an intermediate transfer member, a technique has been known in which a liquid containing a color material aggregation component which promptly aggregates a color material of an ink landing on a surface of the intermediate transfer member is applied thereon. For example, Japanese Patent Laid-Open No. 2009-096175 has disclosed a technique of suppressing the degradation in image quality caused by color material movement in which an aggregation process liquid containing colorless particles for holding a color material aggregated with a color material aggregation component at a predetermined position is applied to a surface of an intermediate transfer member before an ink is supplied.

### SUMMARY OF THE INVENTION

However, since the aggregation process liquid has a high fluidity, a dot diameter of an ink landing thereon spreads to generate a blur, and the image after transfer may become indistinct in some cases. In addition, when inks having different colors are sequentially recorded, since the dot diameter of each ink is large, a phenomenon called bleeding may occur in some cases in which ink droplets landing adjacent to each other are mixed together.

In order to solve this problem, Japanese Patent Laid-Open No. 2009-096175 has also disclosed that after the aggregation process liquid is dried to decrease its fluidity, an ink is supplied to form an intermediate image. However, for this drying, forced drying is required using a heater or the like, or a time for spontaneous drying must be additionally spent. The above drying device and method are responsible for an increase in size of apparatus, an increase in energy consumption, a decrease in printing throughput, and the like.

In addition, when the aggregation process liquid is dried, since the dissolved color material aggregation component and the colorless particles are irregularly precipitated, uniform aggregation may not be obtained in some cases. The present invention was made based on the recognition of the above problems.

The present invention provides a method and an apparatus in which, in transfer type ink jet recording, excellent image transfer can be performed by using a technique of effectively decreasing the fluidity of an aggregation process liquid supplied to an intermediate transfer member.

An image forming method of the present invention includes the steps of: supplying a first liquid for aggregating a color material of an ink to be used and a second liquid which performs a gel reaction with the first liquid on an intermediate transfer member; supplying the ink to a region on which the first liquid and the second liquid are supplied to form an intermediate image on the intermediate transfer member; and transferring the intermediate image to a recording medium.

Further features of the present invention will become apparent from the following description of exemplary embodiments with reference to the attached drawings.

### BRIEF DESCRIPTION OF THE DRAWINGS

FIG. 1 is a cross-sectional view showing the entire structure of an image forming apparatus.

FIGS. 2A to 2C are cross-sectional views showing a process from the formation of an intermediate image to the transfer thereof.

### DESCRIPTION OF THE EMBODIMENTS

The basic concept will be described prior to description of embodiments of the present invention. As described above, when the intermediate image is formed, if an ink landing surface has a high fluidity, an ink landing thereon will be blurred, and the image quality is degraded.

In this embodiment, this problem is solved in such a way that as the ink landing surface, an aggregate layer in the form of a gel (semi-solid solution) is used in order to decrease the fluidity. Therefore, in order to form the intermediate image, before an ink is supplied, a first liquid for aggregating a color material of an ink to be used and a second liquid which performs a gel reaction with the first liquid are supplied on an intermediate transfer member. Although it is preferred that after the first liquid is supplied, the second liquid be supplied to a region on which the first liquid is supplied, the first and the second liquids may be supplied in a reverse order or at the same time.

The first liquid contains a color material aggregation component for aggregating a color material. The second liquid contains a reactant to be aggregated by a reaction with the first liquid. When the first liquid and the second liquid are mixed together, an aggregate of the reactant is generated, and a gel aggregate layer is formed on the intermediate transfer member. The dot diameter of an ink landing on the gel aggregate layer which has a decreased fluidity is not likely to spread. Therefore, a transferred image is suppressed from being indistinct, and/or bleeding caused by mixing between adjacent dots is suppressed from being generated. In addition, a holding power of the gel aggregate layer which fixes to an ink landing position a color material to be aggregated while permeating in a depth direction of the aggregate layer is higher than a liquid layer containing fine particles as disclosed in Japanese Patent Laid-Open No. 2009-096175. Hence, the intermediate image on the intermediate transfer member can be maintained to have a high quality, and the image quality after the transfer is improved.

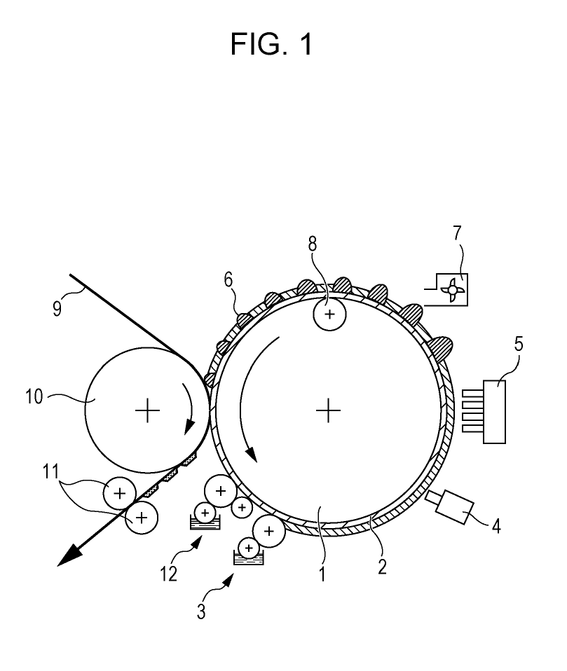

FIG. 1 is a cross-sectional view showing the entire structure of an image forming apparatus according to the embodiment. An intermediate transfer member 1 is formed of a rotating member, and a surface layer 2 is provided on the surface thereof. As a unit performing a basic process, along the periphery of the intermediate transfer member 1, there are provided a liquid coating portion 3 supplying the first liquid, an ink jet head 4 supplying the second liquid, an ink jet head unit 5 forming an intermediate image, and a transfer roller 10 transferring the intermediate image to a recording medium. Between the ink jet head unit 5 and the transfer roller 10, in order to decrease moisture of a supplied ink for a short period of time, a moisture removal portion 7 and a heating portion 8 are provided. Between the transfer roller 10 and the liquid coating portion 3, in order to remove an ink remaining on the intermediate transfer member after the transfer, a cleaning portion 12 is provided. In order to fix the image transferred to a recording medium 9 for a short period of time, a fixing roller 11 is provided.

The intermediate transfer member 1 rotates in the arrow direction shown in the figure, the first liquid is supplied to the surface layer 2 by the liquid coating portion 3, and subsequently, the second liquid is supplied by the ink jet head 4. Next, from the ink jet head unit 5 having a plurality of nozzle lines corresponding to a plurality of colors, inks are supplied according to image data, and an intermediate image 6 is formed. The intermediate image thus formed is controlled before the transfer by the moisture removal portion 7 and the heating portion 8 so as to have an ink viscosity suitable for the transfer. Subsequently, the intermediate image is transferred on a recording surface of the recording medium 9 by the transfer roller 10. After the transfer, the surface of the intermediate transfer member is cleaned by the cleaning portion 12. A final image is repeatedly formed on the recording medium 9 by repeatedly rotating the intermediate transfer member 1 so that the above steps are performed as one cycle. By exchanging the position of the liquid coating portion 3 and that of the ink jet head 4, the second liquid and the first liquid may be supplied in this order. In addition, the liquid coating portion 3 and the ink jet head 4 may be provided at the same position so as to simultaneously supply the first liquid and the second liquid.

The intermediate transfer member 1 may have a roller or a belt shape. A drum-shaped intermediate transfer member formed from a lightweight metal, such as an Al alloy, is used in consideration of required performances, such as the stiffness which can withstand pressure application at the time of transfer, the dimensional accuracy, and the reduction in rotational inertia.

Although the surface layer 2 may have an ink permeability (ink absorbency) when the intermediate transfer member is not repeatedly used, when the intermediate transfer member is repeatedly used, a material having non-permeability (nonabsorbency) is used. If being able to be cleaned by cleaning, a material having permeability can even be repeatedly used. However, when a material having permeability is used, a larger amount of ink must be supplied on the intermediate transfer member, and hence the use of this material is not preferable in terms of the material use efficiency, the image quality, and the cleaning property of the intermediate transfer member. As the surface layer on the intermediate transfer member, in consideration of the transfer rate and the cleaning property, a material having non-permeability (nonabsorbency) is preferably used, and a material which is processed to improve release properties is preferably used. In this embodiment, the release properties indicate properties which enable materials for an ink, a color material aggregation component, and a transparent ink not to easily adhere on the surface and which also enable the above materials to be peeled off when they adhere to the surface. Higher release properties are advantageous in terms of the load applied during cleaning and the transfer rate of ink; however, on the other hand, the critical surface tension of the material is decreased, and a liquid, such as an ink, adhering thereto is liable to be repelled, so that an image is difficult to maintain. As an index of preferable release properties, for example, there may be mentioned a critical surface tension of 30 mN/m or less and a contact angle to water of 75° or more. In particular, the surface layer 2 is formed, for example, by a surface treatment for improving the release properties, such as Teflon (registered trademark) processing or silicone oil application, performed on the periphery of the intermediate transfer member 1.

Although being shown by a roll coater by way of example, the liquid coating portion 3 (first supply device) is not limited thereto. For example, a spray coater and a slit coater may also be mentioned besides the roll coater.

The ink jet head 4 (second supply device) and the ink jet head unit 5 are heads discharging inks from many nozzles by an inkjet method, and for example, a thermal method, a piezo method, an electrostatic method, or an MEMS method may be applied thereto. In addition, these heads may be any one of a line head and a serial head.

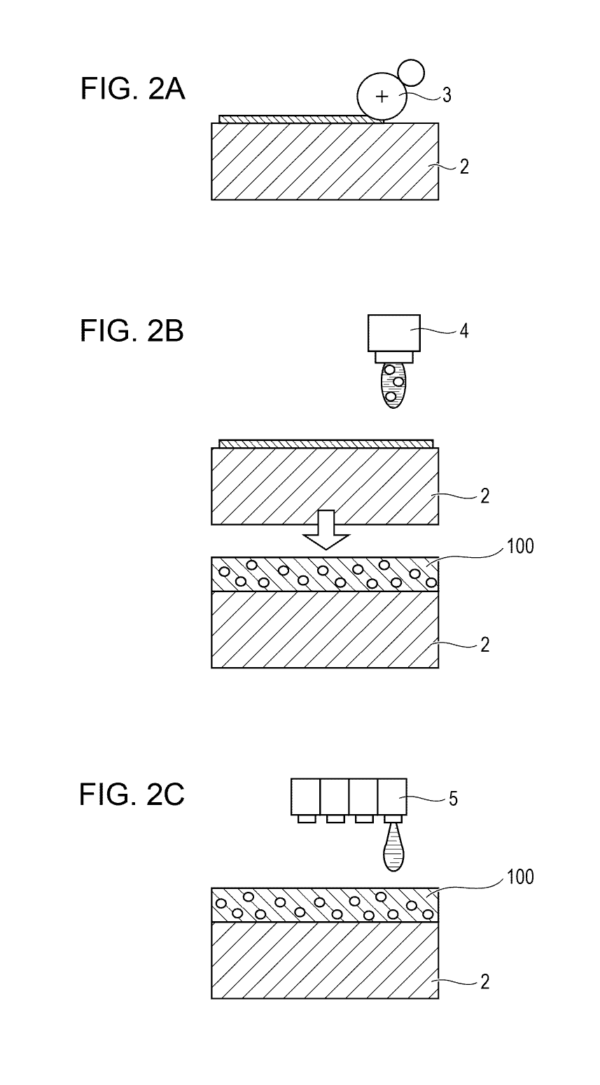

A process from the formation of the intermediate image on the intermediate transfer member to the transfer of the intermediate image can be roughly divided into four steps (a) to (d). Hereinafter, each step will be described in detail. FIGS. 2A to 2C each show the state of the intermediate transfer member surface in each of the steps (a) to (c). Incidentally, in the following description, the “intermediate transfer member surface” indicates the “surface of the surface layer on the intermediate transfer member”.

### (a) Step of Supplying First Liquid

In the step (a), an aggregation promotion liquid (first liquid) containing a color material aggregation component is supplied to the surface layer 2 on the intermediate transfer member using the liquid coating portion 3 (first supply device) (see FIG. 2A). In this step, the color material aggregation component is a material holding the intermediate image on the transfer member by increasing the viscosity of ink by promptly aggregating the color material of an ink which lands on the intermediate transfer member surface.

As the color material aggregation component, in particular, metal ions are effectively used for general dye inks and pigment inks. As the metal ions used as the color material aggregation component, for example, divalent metal ions, such as Ca²⁺, Cu²⁺, Ni²⁺, Mg²⁺, and Zn²⁺, and trivalent metal ions, such as Fe³⁺ and Al³⁺, may be mentioned. In addition, when being supplied, these ions are preferably supplied in the form of a metal salt solution. As anions of the metal salt, for example, Cl⁻, NO₃⁻, SO₄²⁻, I⁻, Br⁻, ClO₃⁻, RCOO⁻ (R indicates an alkyl group) may be mentioned.

In addition, an organic acid compound having a buffering ability which can change the hydrogen ion concentration (pH) may also be used. As the organic acid compound, for example, an organic carboxylic acid and an organic sulfonic acid may be mentioned. In particular, the organic acid compound is preferably selected from a polyacrylic acid, acetic acid, methanesulfonic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furancarboxylic acid, pyridinecarboxylic acid, coumarinic acid, thiophene carboxylic acid, nicotinic acid, derivatives of these compounds, and salts thereof. Since a crystallized compound of the aggregation component may be precipitated in some cases concomitant with a decrease in solubility to a solvent remaining in the process solution after the process layer formation step, a compound having an asymmetric structure is preferable as the organic acid compound among those mentioned above. These compounds may be used alone, or at least two types thereof may be used in combination.

In addition, in view of ability of aggregating a coloring ink, the pH of the organic acid compound is preferably 1.0 to 4.0, more preferably 1.0 to 3.5, and particularly preferable 1.0 to 3.0.

The amount of the color material aggregation component to be supplied is, for example, preferably set so that the total number of charges of metal ions is equal to or more than the number of charges of reverse polarity ions in the coloring ink. For this purpose, an aqueous solution of the metal salt mentioned above having a concentration of approximately 10 percent by mass may be used, and the coating amount may be enough when a thin film is formed.

In addition, in order to improve the transfer property and the toughness of an image finally formed, a resin component may also be added. A water soluble resin and a water soluble cross-linking agent may also be added. As the material to be used, any material may be used as long as being usable together with the color material aggregation component. When a metal salt having a high reactivity is used as the color material aggregation component, as the water soluble resin, in particular, PVA, PVP, and the like are preferably used. As the water soluble cross-linking agent, oxazoline and carbodiimide, each of which reacts with a carboxylic acid which is preferably used for color material dispersion in ink, are preferably used.

Furthermore, in order to supply a wettability improvement component on the intermediate transfer member 1, a surfactant may also be added. In this embodiment, the wettability improvement component indicates a material which improves the wettability (affinity) of the intermediate transfer member surface and is responsible so that by increasing the surface energy of the intermediate transfer member surface, the aggregation promotion liquid to be subsequently supplied is unlikely to be repelled.

The reason the wettability improvement component is supplied is, as described above, to uniformly supply the aggregation promotion liquid on the intermediate transfer member or to hold the aggregation promotion liquid at a predetermined position on the intermediate transfer member. When the aggregation promotion liquid is not uniformly supplied, and a place is present on the intermediate transfer member at which an ink directly lands, the color material of the ink is not promptly aggregated at the place described above, and dots adjacent to each other are mixed together while having fluidity; hence, the bleeding may occur in some cases. The surfactant which can be used is not particularly limited. In accordance with the surface layer to be used, for example, the surfactant may be selected from general surfactants, such as a cationic surfactant, an anionic surfactant, a nonionic surfactant, an amphoteric surfactant, a fluorinated surfactant, and a silicone surfactant. In addition, at least two types of those mentioned above may be mixed together for the use. Among those mentioned above, the fluorinated surfactant and the silicone surfactant each have an excellent effect and are suitable materials. Although the supply amount of the wettability improvement component is not particularly limited as long as the aggregation promotion liquid can be uniformly supplied, in view of image stability and drying property, a smaller supply amount is more preferable. In addition, a supply area (supply position) may also be restricted, and for example, when the wettability improvement component is supplied only to an image forming area (position at which an image fixing component and an ink are supplied), the material use efficiency and the drying property can also be improved.

### (b) Step of Supplying Second Liquid

In the step (b), a transparent reaction liquid (second liquid) for forming a gel aggregate layer 100 by a reaction with the aggregation promotion liquid is supplied by the ink jet head 4 (second supply device) on the intermediate transfer member 1 provided with the aggregation promotion liquid (first liquid). On the intermediate transfer member provided with the aggregation promotion liquid containing the color material aggregation component, the transparent reaction liquid containing a reactant which reacts with the color material aggregation component is further supplied. An aggregation reaction, a so-called gel reaction, occurs between the reactant and the color material aggregation component in a mixed liquid in which the two types of liquids are mixed together. In order to decrease the fluidity of the liquid, the aggregated reactant forms the gel aggregate layer 100 (see FIG. 2B).

As the reactant contained in the transparent reaction liquid used in the step (b) with the color material aggregation component, in particular, a colorless anionic polymer is preferably used. The “colorless” in this specification indicates that when 0.1 g/m² of a compound present in the form of solid is supplied, the absorption concentration in the visible region is 0.1 or less. As the colorless anionic polymer, for example, there may be mentioned some acrylic acid-based polymers, such as a styrene-acrylic acid-ethyl acrylate copolymer, a polyacrylic acid, a polymethacrylic acid, and a polymethylmethacrylate, and some celluloses, such as carboxyl methyl cellulose.

In addition, as the reactant, some metal oxides, such as silica and alumina, may also be used. These metal oxides are present in a liquid as metal oxide ions having negative charges and react with the color material aggregation component to form the aggregate as described above.

In Example 1 which will be described later, in the step (a), metal ions are used as the color material aggregation component, and in the step (b), an anionic polymer is used as the reactant. Since the metal ions in the aggregation promotion liquid exhibit cationic properties, and the anionic polymer, the reactant, in the transparent reaction liquid exhibits anionic properties, when the aggregation promotion liquid and the transparent reaction liquid come into contact with each other on the intermediate transfer member, these compounds react with each other, and the anionic polymer is aggregated. Since the aggregate of the anionic polymer is formed as described above, the fluidity of the mixed liquid is decreased, and the gel aggregate layer 100 is formed.

### (c) Step of Forming Intermediate Image

In the step (c), to the gel aggregate layer 100 formed on the intermediate transfer member surface by supplying the color material aggregation component and the transparent ink, an ink corresponding to a desired color is discharged from the ink jet head unit 5 in accordance with the image data, and the intermediate image is formed on the intermediate transfer member (see FIG. 2C).

The ink used in the step (c) is not particularly limited, and an aqueous ink can be preferably used which contains a general anionic dye or self-dispersing pigment having a negative charge as a color material for ink and an aqueous liquid medium for dissolving and/or dispersing the above color material. In particular, when metal ions are used as the color material aggregation component, the self-dispersing pigment having a negative charge forms a good image having a high toughness.

As the particular dyes, for example, there may be mentioned C.I. Direct Blue 6, 8, 22, 34, 70, 71, 76, 78, 86, 142 and 199; C.I. Acid Blue 9, 22, 40, 59, 93, 102, 104, 117, 120, 167, and 229; C.I. Direct Red 1, 4, 17, 28, 83, and 227; C.I. Acid Red 1, 4, 8, 13, 14, 15, 18, 21, 26, 35, 37, 249, 257, and 289; C.I. Direct Yellow 12, 24, 26, 86, 98, 132, and 142; C.I. Acid Yellow 1, 3, 4, 7, 11, 12, 13, 14, 19, 23, 25, 34, 44, and 71; C.I. Food Black 1 and 2; and C.I. Acid Black 2, 7, 24, 26, 31, 52, 112, and 118.

As the pigment, for example, there may be mentioned C.I. Pigment Blue 1, 2, 3, 15:3, 16, and 22; C.I. Pigment Red 5, 7, 12, 48 (Ca), 48 (Mn), 57 (Ca), 112, and 122; C.I. Pigment Yellow 1, 2, 3, 13, 16, and 83; Carbon Black No. 2300, 900, 33, 40, 52, MA7, MA8, and MCF88 (manufactured by Mitsubishi Kasei); RAVEN 1255 (manufactured by Colombia), REGAL 330R, 660R, and MOGUL (manufactured by Cabot); and Color Black FW1, FW18, 5170, 5150, and Printex 35 (manufactured by Degussa).

The forms of these pigments are not particularly limited, and any one selected, for example, from a self-dispersion type, a resin dispersion type, and a microcapsule type may be used. As a dispersant for the pigment used in this case, an aqueous dispersion resin having a weight average molecular weight of approximately 1,000 to 15,000 can be preferably used. In particular, for example, there may be mentioned a vinyl water soluble resin; block copolymers or random copolymers of styrene and its derivative, vinylnaphthalene and its derivative, an aliphatic alcohol ester of an α,β-ethylenic unsaturated carboxylic acid, acrylic acid and its derivative, maleic acid and its derivative, itaconic acid and its derivative, and fumaric acid and its derivative; and salts of the aforementioned compounds. At least two types of these ink materials for each of the dye, the pigment, the dispersion form, and the dispersant may be used in combination by mixing.

In addition, in order to improve the toughness of the image which is finally formed, a water soluble resin and a water soluble cross-linking agent can also be added. As the material to be used, any material may be used as long as being usable together with the ink component. As the water soluble resin, for example, the dispersion resin described above is preferably further added. As the water soluble cross-linking agent, oxazoline and carbodiimide, each having a low reactivity, are preferably used in view of ink stability.

In an aqueous liquid medium forming an ink with the color material described above, an organic solvent can be contained, and the amount of this organic solvent is an important factor to determine physical properties of the ink at the time of image transfer. The reason for this is that the ink transferred from the intermediate transfer member to the recording medium includes almost only the color material and a high boiling point organic solvent. As the organic solvent to be used, the following water soluble solvents are preferably used.

For example, there may be mentioned a polyethylene glycol, a polypropylene glycol, ethylene glycol, propylene glycol, butylene glycol, triethylene glycol, thiodiglycol, hexylene glycol, diethylene glycol, ethylene glycol monomethyl ether, diethylene glycol monomethyl ether, and glycerin, and among those mentioned above, at least two types thereof may be used in combination by mixing. As a component adjusting the viscosity, the surface tension, and the like, an alcohol, such as ethyl alcohol or isopropyl alcohol, and/or a surfactant may also be added in the ink.

The composition ratio of the components forming the ink is not particularly limited and can be appropriately adjusted in accordance with dischargeable ranges determined by a selected ink jet recording method, a discharge power of a head, a nozzle diameter, and the like. In general, an ink prepared so as to contain, on a mass basis, 0.1% to 10% of a color material, 0.1% to 20% of a resin component, 5% to 40% of a solvent, 0.01% to 5% of a surfactant, and the balance being water can be used.

When the ink is discharged on the intermediate transfer member surface, ink discharge is performed on the gel aggregate layer containing the color material aggregation component formed in the steps (a) and (b) in consideration that the image formed thereby is reversed by the transfer. That is, a mirror image is formed on the intermediate transfer member, the mirror image being obtained by mirror-reversing an image which is to be formed on the recording medium on which the transfer is performed.

A decrease in time from the intermediate image formation to the transfer contributes to an improvement in the whole printing throughput. Since water removal is promoted by the moisture removal portion 7 and the heating portion 8 from the intermediate image formation to the transfer, the time therebetween is decreased.

### (d) Transfer Step

By the transfer roller 10, an image forming surface of the intermediate transfer member 1 is transferred to the recording medium 9. Since the viscosity of the ink of the intermediate image is appropriately increased on the intermediate transfer member 1 at this stage, a good image can be formed on the recording medium, such as a printing sheet having low ink absorbency or a film having no ink absorbency.

The technical important point of this embodiment is that after the gel aggregate layer containing a color material aggregation component is formed on the intermediate transfer member, the intermediate image is formed on the aggregate layer. Since the aggregation process liquid is gelled without drying so as to decrease the fluidity thereof, and the ink is supplied thereon, the dot diameter of an ink landing on the aggregation process liquid is not likely to spread, and a good image having excellent color reproducibility is formed on the recording medium. Since no drying device is required when the fluidity of the aggregation process liquid is decreased, reduction in size of the apparatus, reduction in power consumption, and a high printing throughput can be realized.

Next, more particular examples and comparative examples will be described. Incidentally, “part” and “%” in the specification are each based on a mass basis unless otherwise particularly noted.

### Example 1

### (a) Step of Supplying First Liquid

In this example, as the intermediate transfer member, an aluminum-made drum coated with a silicone rubber (KE12 manufactured by Shin-Etsu Chemical Co., Ltd.) having a hardness of 40° and a thickness of 0.5 mm was used. First, an aggregation promotion liquid (A) shown below was applied to the intermediate transfer member surface by a roll coater. The coating thickness was set to approximately 1 μm.

### Aggregation Promotion Liquid (A)

Mg (NO₃)₂.6H₂O: 7 parts
Surfactant (Acetylenol EH, manufactured by Kawaken Fine Chemicals Co., Ltd.): 1 part
Diethylene glycol: 20 parts
Hexylene glycol: 10 parts
Ion-exchange water: 62 parts

### (b) Step of Supplying Second Liquid

Next, a transparent reaction liquid (A) containing a styrene-acrylic acid-ethyl acrylate copolymer (acid number: 180, weight average molecular weight: 4,000) as a reactant was supplied by an ink jet head (nozzle density: 1,200 dpi, discharge amount: 3 picoliters (pl), drive frequency: 12 kHz).

### Transparent Reaction Liquid (A)

Styrene-acrylic acid-ethyl acrylate copolymer (acid number: 180, weight average molecular weight: 4,000): 11 parts
Glycerin: 7.5 parts
Diethylene glycol: 7.5 parts
Ion-exchange water: 74 parts

### (c) Step of Forming Intermediate Image

A mirror-reversed character image was formed by an ink jet head (nozzle density: 1,200 dpi, discharge amount: 3 pl, drive frequency: 12 kHz) on the intermediate transfer member on which the gel aggregate layer 100 was formed in the above steps (a) and (b). In this case, the following composition was used as the ink.
Pigment (Carbon Black MCF88, manufactured by Mitsubishi Chemical Corp.): 3 parts
Cyan: Pigment Blue 15: 3 parts
Magenta: Pigment Red 7: 3 parts
Yellow: Pigment Yellow 74: 3 parts
Styrene-acrylic acid-ethyl acrylate copolymer (acid number: 180, weight average molecular weight: 4,000): 1 part
Glycerin: 10 parts
Ethylene glycol: 5 parts
Surfactant (Acetylenol EH, manufactured by Kawaken Fine Chemicals Co., Ltd.): 1 part
Ion-exchange water: 80 parts

### (d) Transfer Step

The intermediate transfer member processed by the series of the above steps and surface-coated printing paper having low ink absorbency (Npi coat having a ream weight of 40.5 kg, manufactured by Nippon Paper Industries Co., Ltd.) were brought into contact with each other by a transfer roller, and a recorded image on the intermediate transfer member was transferred. The dot diameter of the ink at this stage was 22 μm, and the blur rate thereof was 1.2.

### Example 2

### (a) Step of Supplying First Liquid

In this example, as the intermediate transfer member, an aluminum-made drum coated with a silicone rubber (KE12, manufactured by Shin-Etsu Chemical Co., Ltd.) having a hardness of 40° and a thickness of 0.3 mm was used. First, an aggregation promotion liquid (B) shown below was applied to the intermediate transfer member surface by a roll coater. The coating thickness was set to approximately 1 μm.

### Aggregation Promotion Liquid (B)

Mg(NO₃)₂.6H₂O: 7 parts
Surfactant (Acetylenol EH, manufactured by Kawaken Fine Chemicals Co., Ltd.): 1 part
Diethylene glycol: 20 parts
Hexylene glycol: 10 parts
Ion-exchange water: 62 parts

### (b) Step of Supplying Second Liquid

Next, alumina pigment droplets (NANOBYK-3600, manufactured by BYK Japan K. K.) were supplied by an ink jet head (nozzle density: 1,200 dpi, discharge amount: 3 pl, drive frequency: 12 kHz).

### Transparent Reaction Liquid (B)

Alumina (NANOBYK-3600, manufactured by BYK Japan K. K.): 10 parts
Styrene-acrylic acid-ethyl acrylate copolymer (acid number: 180, weight average molecular weight: 4,000): 1 part
Glycerin: 7.5 parts
Diethylene glycol: 7.5 parts
Ion-exchange water: 74 parts

### (c) Step of Forming Intermediate Image

A mirror-reversed character image was formed by an ink jet head (nozzle density: 1,200 dpi, discharge amount: 3 pl, drive frequency: 12 kHz) on the intermediate transfer member on which the gel aggregate layer 100 was formed in the above steps (a) and (b). In this case, the following composition was used as the ink.
Pigment (Carbon Black MCF88, manufactured by Mitsubishi Chemical Corp.): 3 parts
Cyan: Pigment Blue 15: 3 parts
Magenta: Pigment Red 7: 3 parts
Yellow: Pigment yellow 74: 3 parts
Styrene-acrylic acid-ethyl acrylate copolymer (acid number: 180, weight average molecular weight: 4,000): 1 part
Glycerin: 10 parts
Ethylene glycol: 5 parts
Surfactant (Acetylenol EH, manufactured by Kawaken Fine Chemicals Co., Ltd.): 1 part
Ion-exchange water: 80 parts

In order to enable the ink of the intermediate image thus formed to have an appropriate viscosity in a short period of time, an excessive solvent was removed from the ink aggregate by heating from the rear surface of the intermediate transfer member using the heater roller 8. Since the transfer was performed to the recording medium after the ink aggregate was condensed, good fixability and glossiness could be imparted to the image after the transfer.

### (d) Transfer Step

The intermediate transfer member processed by the series of the above steps and surface-coated printing paper having low ink absorbency (Npi coat having a ream weight of 40.5 kg, manufactured by Nippon Paper Industries Co., Ltd.) were brought into contact with each other by a transfer roller, and a recorded image on the intermediate transfer member was transferred. The dot diameter of the ink at this stage was 22 μm, and the blur rate thereof was 1.2.

### Comparative Example 1

In order to compare with the above examples, an example will be described in which a recorded image is formed without using a transparent ink.

In Example 1, image recording was performed in a manner similar to that in Example 1 except that the transparent ink of the step (b) was not supplied. As a result, the intermediate image after the transfer was blurred, the diameter of its dot was 35 μm, and the blur rate was 2.0; hence, a sufficient intermediate image was not obtained.

### Comparative Example 2

In order to compare with the above examples, an example will be described in which a recorded image is formed using a colorless compound which does not react with the color aggregation component.

In the step (b) of Example 1, image recording was performed in a manner similar to that of Example 1 except that a polyolefin was used instead of the styrene-acrylic acid-ethyl acrylate copolymer. As a result, the intermediate image after the transfer was blurred, the diameter of its dot was 35 μm, and the blur rate was 2.0; hence, a sufficient intermediate image was not obtained.

From the above comparative examples, it was confirmed that by using a reactant which reacts with the color material aggregation component described in this embodiment to form the gel aggregate layer 100, the blur rate can be significantly decreased, and the image quality can be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese

Patent Application No. 2010-245490 filed Nov. 1, 2010, which is hereby incorporated by reference herein in its entirety.

What is claimed is:

1. An image forming method comprising the steps of:
supplying a first liquid for aggregating a color material of an ink to be used and a second liquid which performs a gel reaction with the first liquid on an intermediate transfer member;
supplying the ink to a region on which the first liquid and the second liquid are supplied to form an intermediate image on the intermediate transfer member; and
transferring the intermediate image to a recording medium.

2. The image forming method according to claim 1, wherein the first liquid is first supplied, and the second is then supplied to a region on which the first liquid is supplied.

3. The image forming method according to claim 2, wherein the first liquid contains a color material aggregation component for aggregating the color material, the second liquid contains a reactant to be aggregated by a reaction with the first liquid, and when the first liquid and the second liquid are mixed together, an aggregate of the reactant is generated to form a gel layer on the intermediate transfer member.

4. The image forming method according to claim 3, wherein the reactant contains a colorless anionic polymer.

5. The image forming method according to claim 3, wherein the color material aggregation component contains metal ions.

6. The image forming method according to claim 1, wherein the color material of the ink contains at least one of a pigment and a dye, the pigment is a self-dispersing pigment having a negative charge, and the dye is an anionic dye.

7. The image forming method according to claim 1, wherein the intermediate transfer member has a surface processed to improve release properties, and the first liquid contains a surfactant which improves the affinity for the surface.

8. An image forming apparatus comprising:
an intermediate transfer member;
a first supply device to supply a first liquid for aggregating a color material of an ink to be used to the intermediate transfer member;
a second supply device to supply a second liquid which performs a gel reaction with the first liquid to the intermediate transfer member;
an ink jet head which supplies the ink to a region on which the first liquid and the second liquid are supplied to form an intermediate image on the intermediate transfer member; and
a transfer device which transfers the intermediate image to a recording medium.
